(19) United States
(12) Patent Application Publication
(10) Pub. No.: US 2014/0085491 A1
(43) Pub. Date: Mar. 27, 2014

(54) IMAGING DEVICE AND CRADLE

(71) Applicant: JVC KENWOOD CORPORATION, Yokohama-shi (JP)

(72) Inventors: Masaaki IMAI, Yokohama-shi (JP); Kouji OHISHI, Yokohama-shi (JP); Tsuyoshi OKUNISHI, Yokohama-shi (JP)

(73) Assignee: JVC KENWOOD CORPORATION, Yokohama-shi (JP)

(21) Appl. No.: 14/035,342

(22) Filed: Sep. 24, 2013

(30) Foreign Application Priority Data
Sep. 27, 2012 (JP) 2012-214276
Sep. 27, 2012 (JP) 2012-214278
Sep. 27, 2012 (JP) 2012-214279

(51) Int. Cl. H04N 5/232

(52) U.S. Cl. CPC H04N 5/232
USPC 348/207.11

(57) ABSTRACT

An imaging device mounted on a cradle configured to control any one of a pan operation and a tilt operation includes: a control signal output unit configured to output a control signal that executes any one of a desired pan operation and tilt operation to the cradle.

### CROSS-REFERENCE TO RELATED APPLICATIONS

This application is based upon and claims the benefit of priority from Japanese Patent Application No. 2012-214276, filed on Sep. 27, 2012, Japanese Patent Application No. 2012-214278, filed on Sep. 27, 2012 and Japanese Patent Application No. 2012-214279, filed on Sep. 27, 2012, the entire contents of which are incorporated herein by reference.

### BACKGROUND OF THE INVENTION

1. Field of the Invention

The present invention relates to an imaging device and a cradle.

2. Description of the Related Art

As techniques of these types, a camera cradle is disclosed in Japanese Laid-open Patent Publication No. 2008-141537, which is connected to a digital camera to read out image data stored in the digital camera and to charge the digital camera. The camera cradle is connected to the digital camera using a charging connector or an USB connector. In addition, the camera cradle is connected to a client PC with a LAN cable and is configured to be capable of controlling a shutter photographing function of the digital camera based on a command from the client PC. Further, a pan motor and a tilt motor are embedded in the camera cradle so as to implement a pan operation or a tilt operation of the digital camera. The camera cradle is configured to be capable of controlling an attitude of the digital camera based on a command from the client PC.

However, according to the configuration disclosed in Japanese Laid-open Patent Publication No. 2008-141537, it is not possible to control a pan operation or a tilt operation of a camera cradle from an imaging device side.

### SUMMARY OF THE INVENTION

It is an object of the present invention to at least partially solve the problems in the conventional technology.

According to an aspect of the present invention, an imaging device mounted on a cradle configured to control any one of a pan operation and a tilt operation includes: a control signal output unit configured to output a control signal that executes any one of a desired pan operation and tilt operation to the cradle.

According to another aspect of the present invention, a cradle that mounts an imaging device and configured to control any one of a pan operation and a tilt operation includes: a pan motor used for any one of a pan operation and a tilt motor used for a tilt operation; a motor driving unit that drives any one of the pan motor and the tilt motor; and a motor control unit that controls the motor driving unit based on a control signal input from the imaging device.

According to still another aspect of the present invention, a cradle which is mounted with an imaging device and configured to control any one of a pan operation and a tilt operation includes: a control board that is configured to control any one of the pan operation and the tilt operation; and an attachment screw that is screwed into a tripod-attaching female screw unit of the imaging device, and a ground of the control board and the attachment screw are electrically connected to each other.

According to still another aspect of the present invention, a cradle which is mounted with an imaging device and configured to control any one of a pan operation and a tilt operation includes: a control board that is configured to control any one of the pan operation and the tilt operation; a cradle body that accommodates the control board; and a fixture that is detachable to the cradle body and the imaging device, and the fixture includes a fixture body, an attachment screw that is screwed into a tripod-attaching female screw unit of the imaging device while being rotatably supported by the fixture body, the cradle body includes an attaching/holding unit configured to hold the fixture and a contact with which the attachment screw of the fixture comes in contact when the attachment screw is held to the attaching/holding unit, while being supported by the attaching/holding unit, and a ground of the control board and the contact are electrically connected to each other.

According to still another aspect of the present invention, a cradle which is mounted with an imaging device and configured to control any one of a pan operation and a tilt operation includes: a control board that is configured to control any one of the pan operation and the tilt operation; a cradle body that accommodates the control board; and a connection cable that is configured to connect the control board to the imaging device, and a cable accommodating groove is formed in the cradle body to accommodate the connection cable.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an overall view of a remote cradle control system;

FIG. 2 is a perspective view of a camcorder;

FIG. 3 is a perspective view of the camcorder to which a plate is attached;

FIG. 4 is a block diagram illustrating functions of the camcorder;

FIG. 5 is a perspective view of a cradle;

FIG. 6 is a top view of the cradle;

FIG. 7 is an exploded perspective view of the cradle;

FIG. 8 is a partial perspective view of the cradle;

FIG. 9 is a partial perspective view of the cradle;

FIG. 10 is an exploded perspective view of the plate;

FIG. 11 is a block diagram illustrating functions of the cradle;

FIG. 12 is a front view of a smart phone;

FIG. 13 is a block diagram illustrating functions of the smart phone; and

FIG. 14 is a time chart of the remote cradle control system.

### DETAILED DESCRIPTION OF THE PREFERRED EMBODIMENTS

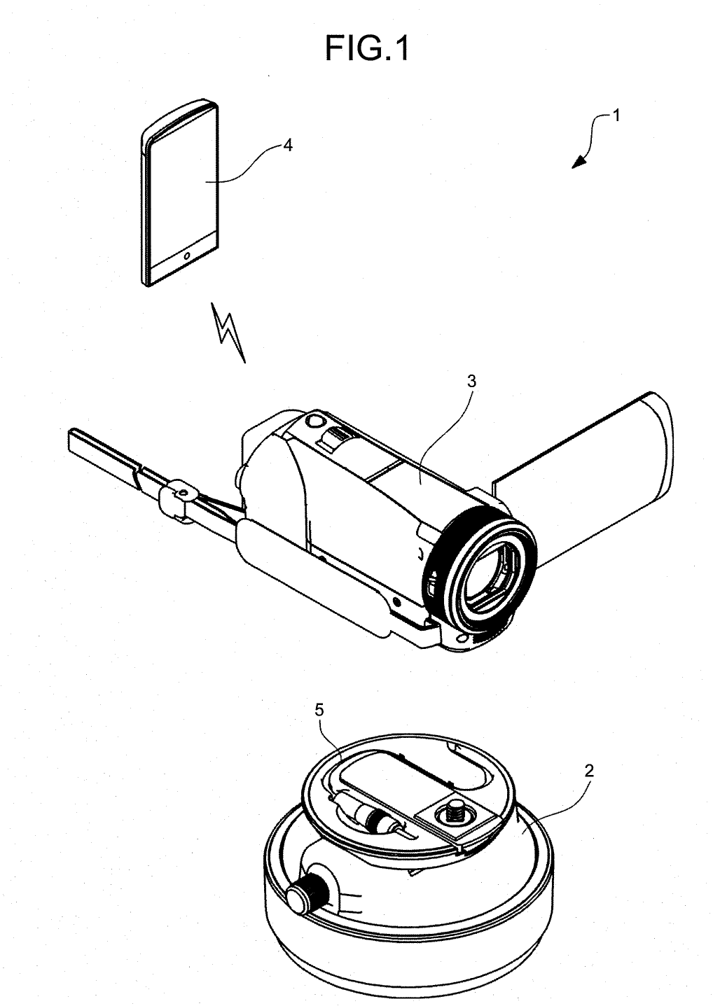

An embodiment of the present invention will be described below with reference to FIGS. 1 to 14.

In the configuration of the above-described Japanese Laid-open Patent Publication No. 2008-141537, a ground of a control board of a digital camera and a ground of a control board of a camera cradle may be connected to each other using a charging connector or an USB connector. In the configuration of the above-described Japanese Laid-open Patent Publication No. 2008-141537, however, a connection unit between the digital camera and the camera cradle is complicated. One of the objectives of the present embodiment is to provide a technique of connecting the ground of the control board of an imaging device and the ground of the control board of the cradle to each other with a simple configuration. According to the present embodiment, when a tripod-attaching female screw unit of the imaging device is electrically connected to the ground of the control board of the imaging device, it is possible to connect the ground of the control board of the cradle and the ground of the control board of the imaging device to each other with the simple configuration.

Incidentally, there is a method of connecting the imaging device and the cradle to each other using a connection cable. In this case, however, there is a room for improvement in an accommodation of the connection cable. One of the objectives of the present embodiment is to provide a technique of improving the accommodation of the connection cable used for the connection between the imaging device and the cradle. According to the present embodiment, it is possible to accommodate the connection cable at the time of not using the connection cable.

As illustrated in FIG. 1, a remote cradle control system 1 includes a cradle (camera platform) 2, a camcorder (imaging device) 3 to be mounted on the cradle 2, and a smart phone 4 which is a form of an information terminal. The cradle 2 has a pan function for panning the camcorder 3 and a tilt function for tilting the camcorder 3. In the cradle 2 of the present embodiment, the pan function is performed by an electric power and the tilt function is manually operated. The cradle 2 and the camcorder 3 are connected to each other by a connection cable 5 which is provided in the cradle 2. The camcorder 3 and the smart phone 4 are configured to be capable of conducting a two-way communication through radio communication such as WiFi (registered trademark) and Bluetooth (registered trademark). With the above configuration, in the present embodiment, the pan function of the cradle 2 is remotely controlled through the camcorder 3 by operating the smart phone 4 and a status of the cradle 2, for details, the controlled result of the pan function of the cradle 2 is monitored on the smart phone 4.

Camcorder 3

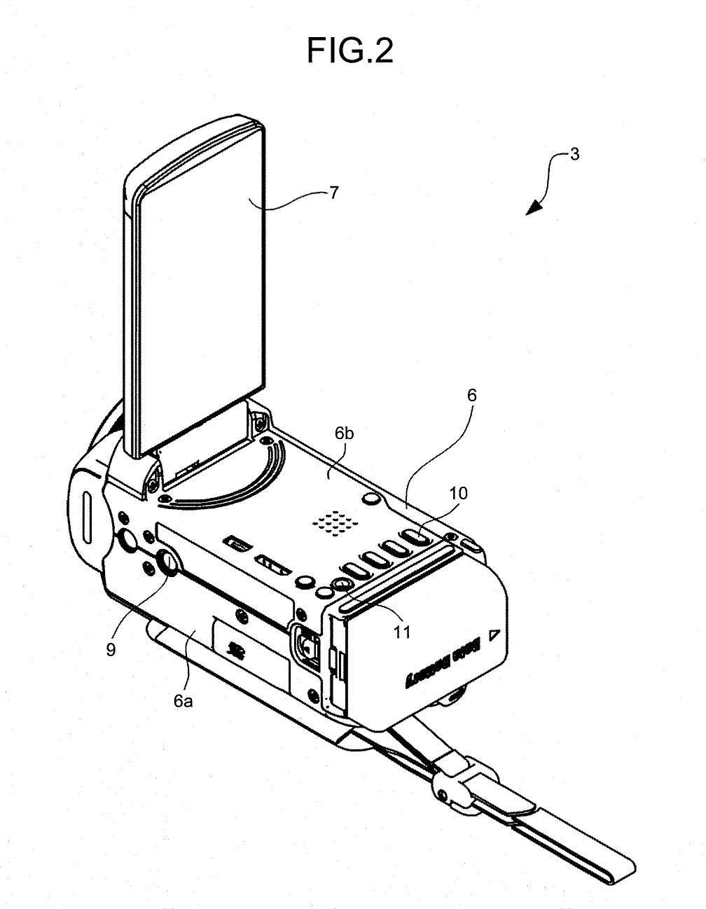

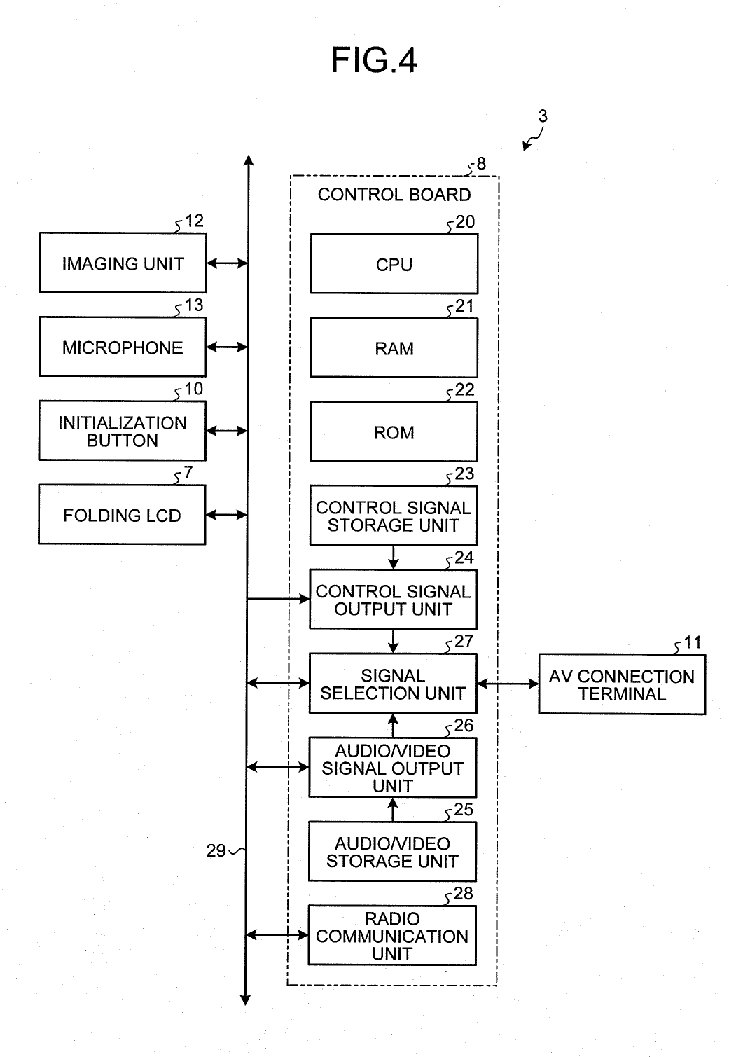

The camcorder 3 will be described with reference to FIGS. 2 to 4. As illustrated in FIGS. 2 to 4, the camcorder 3 includes a camcorder body 6, a folding LCD (Liquid Crystal Display) 7, and a control board 8. The camcorder body 6 is formed in a substantially cuboidal shape. A metallic tripod-attaching female screw unit 9 is disposed at a bottom 6a of the camcorder body 6. The tripod-attaching female screw unit 9 is electrically connected to a ground of the control board 8. An initialization button 10 and an AV connection terminal (connection terminal) 11 are disposed at a left side 6b of the camcorder body 6. The initialization button 10 is a button for initializing the control of the pan operation of the cradle 2. The AV connection terminal 11 is a connection terminal for outputting an audio signal and a video signal to an exterior. The folding LCD 7 is rotatably supported with respect to the camcorder body 6. The folding LCD 7 selectively includes an open state in which the left side 6b of the camcorder body 6 is exposed by separating from the left side 6b of the camcorder body 6 as illustrated in FIG. 2 and a close state in which the left side 6b of the camcorder body 6 is covered. In addition, a touch panel is provided on a display surface of the folding LCD 7. Various instruction inputs can be executed by operating (touching) the display surface of the folding LCD 7 or icons displayed on the display surface. For example, a mode switching icon may be displayed on the display surface of the folding LCD 7. In this case, by touching the mode switching icon, it is possible to switch between a playback mode which displays an image photographed by the camcorder 3 on the folding LCD 7 and a cradle control mode which controls the cradle 2 using the camcorder 3 or the smart phone 4. Further, the camcorder body 6 includes an imaging unit (imaging means) 12 and a microphone (sound collecting means) 13 as illustrated in FIG. 4.

The control board 8 includes a Central Processing Unit (CPU) 20, a Random Access Memory (RAM) 21, and a Read Only Memory (ROM) 22. A control program is stored in the ROM 22. The control program is readout on the CPU 20 and is executed on the CPU 20 to cause hardware such as the CPU 20 to function as a control signal storage unit (control signal storage means) 23, a control signal output unit (control signal output means) 24, an audio/video storage unit (audio/video storage means) 25, an audio/video signal output unit (audio/video signal output means) 26, a signal selection unit (signal selection means) 27, and a radio communication unit (radio communication means) 28.

The control signal storage unit 23 stores a control signal to cause the cradle 2 to execute a desired pan operation. In the present embodiment, the control signal is an analog signal or a digital signal.

The control signal output unit 24 outputs the control signal stored in the control signal storage unit 23 to the cradle 2 based on a command signal input from a bus 29. Specifically, the control signal output unit 24 outputs the control signal stored in the control signal storage unit 23 to the signal selection unit 27 based on the command signal input from the bus 29.

The audio/video storage unit 25 stores an audio signal and a video signal.

The audio/video signal output unit 26 outputs the audio signal or the video signal stored in the audio/video storage unit 25 to the bus 29 or the signal selection unit 27 based on the command input from the bus 29.

The signal selection unit 27 selects either one of the audio signal and the video signal output from the audio/video signal output unit 26 and the control signal output from the control signal output unit 24, as a signal output from the AV connection terminal 11, based on the command input from the bus 29. The selected signal is output to the cradle 2 from the AV connection terminal 11. In addition, the signal selection unit 27 inputs a signal for monitoring the status of the cradle 2, for example, rotational position notifying information (information signal) including a present rotational position of the pan operation of the cradle 2, from the cradle 2.

The radio communication unit 28 performs the radio communication with the smart phone 4.

Cradle 2

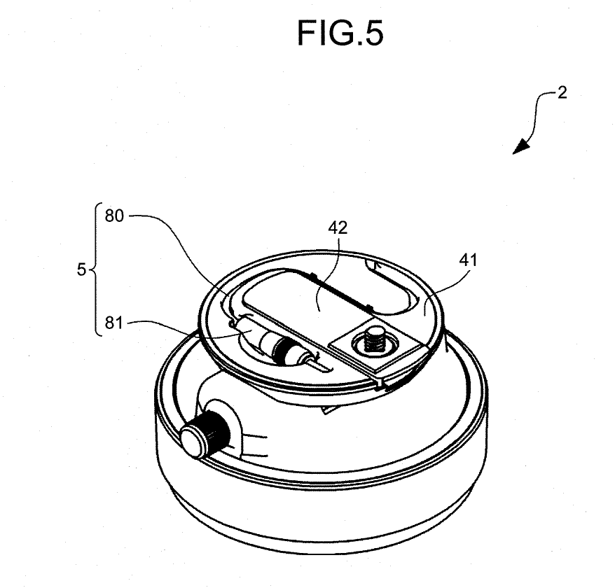

The cradle 2 will be described below with reference to FIGS. 5 to 11. As illustrated in FIGS. 5 to 11, the cradle 2 includes a cradle body 41, a plate 42, a control board 43, and a connection cable 5.

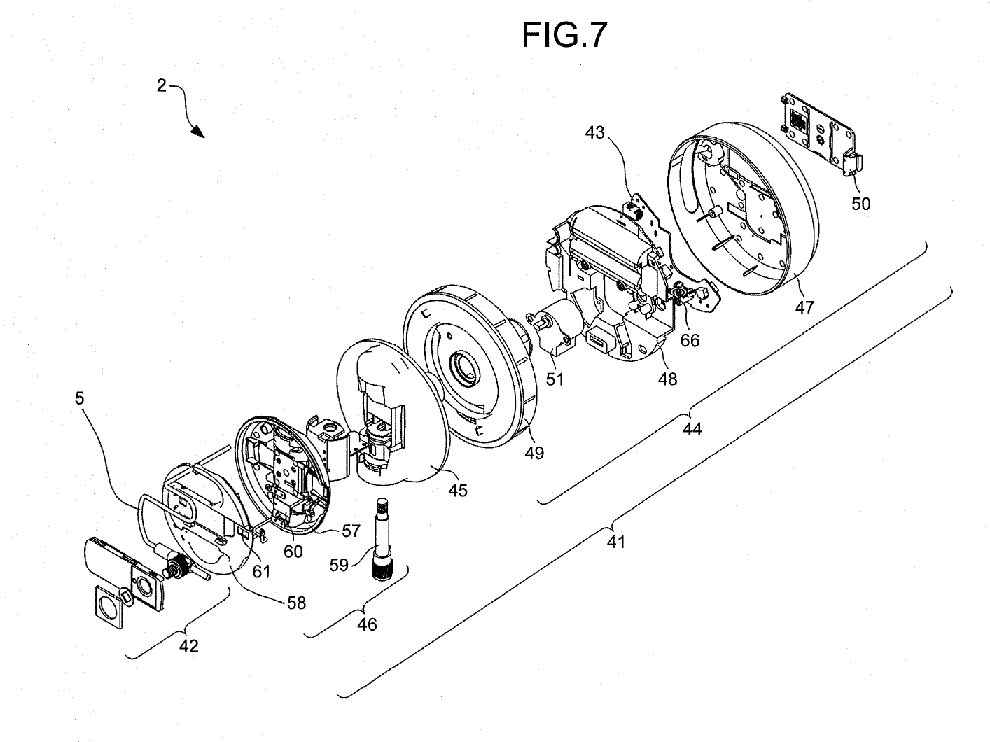

As illustrated in FIG. 7, the cradle body 41 includes a fixing unit 44, a pan movable unit 45, and a tilt movable unit 46.

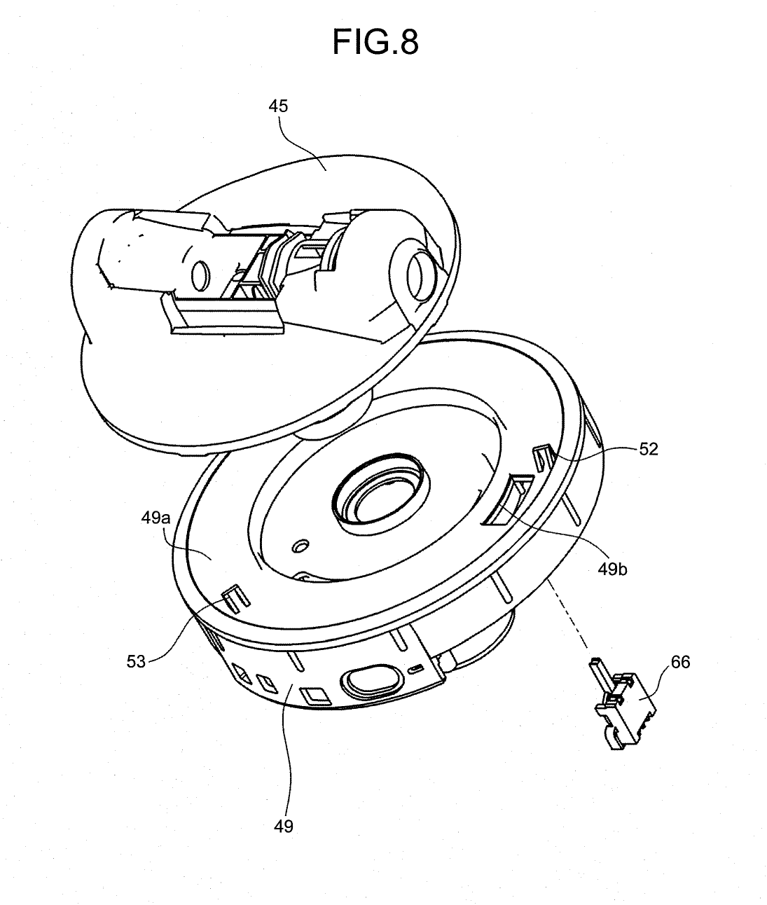

The fixing unit 44 accommodates the control board 43. The fixing unit 44 includes a base 47, a battery holder 48, a base cover 49, a battery case lid 50, a pan motor 51, and an encoder 78. As illustrated in FIG. 8, an over-speed regulation rib 52, an over-speed regulation rib 53, and an end-point switch hole 49b are formed on a top 49a of the base cover 49.

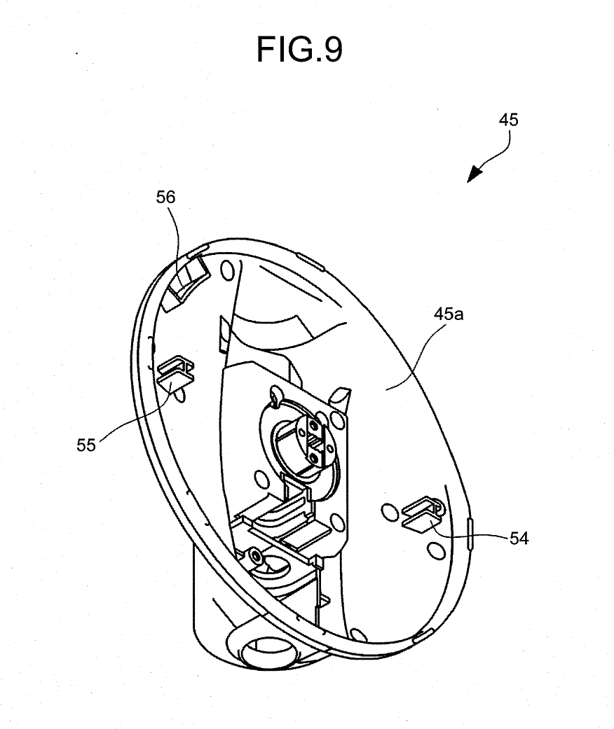

As illustrated in FIGS. 7 and 8, the pan movable unit 45 is supported by the fixing unit 44 so as to be capable of horizontally rotating with respect to the base cover 49 of the fixing unit 44. An output shaft of the pan motor 51 of the fixing unit 44 is fitted into the pan movable unit 45. The rotational position of the output shaft of the pan motor 51 is detected by the encoder 78. The encoder 78 outputs the detected result (rotational position notifying information) to a motor control unit 73. As illustrated in FIG. 9, an over-speed regulation rib 54, an over-speed regulation rib 55, and an end-point switch operation unit 56 are formed on a bottom 45a of the pan movable unit 45.

As illustrated in FIG. 7, the tilt movable unit 46 is supported by the pan movable unit 45 so as to be capable of being inclined with respect to the pan movable unit 45. The tilt movable unit 46 includes a base 57, a top plate 58, a tilt adjustment knob 59, and a contact 60. The tilt adjustment knob 59 is configured to adjust an inclination angle of the tilt movable unit 46 with respect to the pan movable unit 45. The contact 60 is an elastic metal piece and is electrically connected to the ground of the control board 43. The contact 60 is disposed between the base 57 and the top plate 58 and is partially exposed upward from a contact exposing window 61 of the top plate 58.

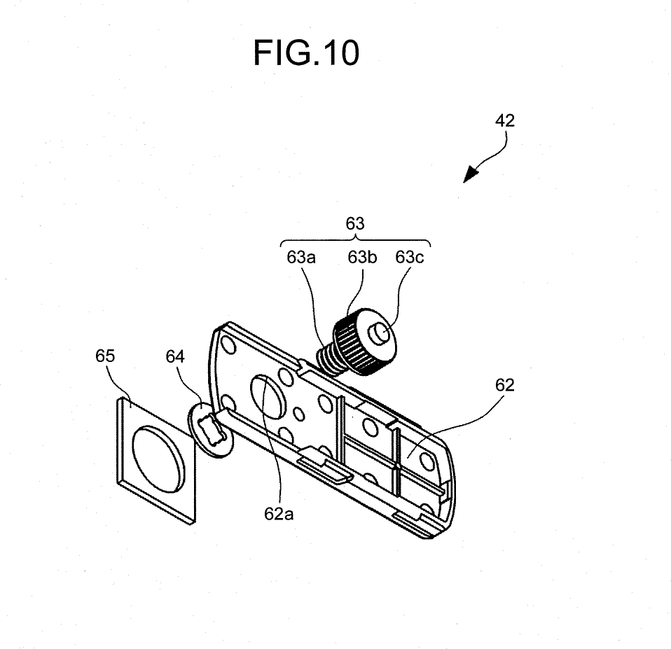

The plate 42 is configured to be attachable to and detachable from the cradle body 41 and the camcorder 3. The plate 42 is previously attached to the camcorder 3 at the time of attaching the camcorder 3 to the cradle body 41. As illustrated in FIG. 10, the plate 42 includes a plate body 62, an attachment screw 63, a screw disengagement preventing washer 64, and a resilient sheet 65. By inserting the attachment screw 63 into a screw hole 62a of the plate body 62 and attaching the screw disengagement preventing washer 64 to the inserted attachment screw 63, the attachment screw 63 is rotatably supported by the plate body 62 and the attachment screw 63 is prevented from being disengaged from the plate body 62. The attachment screw 63 includes a thread 63a, a knob 63b, and a body-side contact tip 63c. The knob 63b is a resin component formed on an outer circumference of the thread 63a. The thread 63a and the body-side contact tip 63c are metal components and are integrally formed.

As illustrated in FIG. 7, an end-point switch 66 is disposed on the control board 43. The end-point switch 66 is configured to detect a horizontal rotation of the pan movable unit 45 with respect to the base cover 49 of the fixing unit 44. The end-point switch 66 is inserted into the end-point switch hole 49b of the base cover 49, as illustrated in FIG. 8 and is operated by an end-point switch operation unit 56 of the pan movable unit 45 illustrated in FIG. 9. For example, a range of movement of the horizontal rotation of the pan movable unit 45 relative to the base cover 49 is substantially 180 degrees; when it reaches the limit of the range of movement, the end-point switch 66 is operated by the end-point switch operation unit 56. That is, a positional regulation on the horizontal rotation direction of one side and the horizontal rotation direction in a direction opposite to the one side of the pan movable unit 45 is implemented by a single end-point switch 66. At this time, for example, when a user strongly rotates the pan movable unit 45 with respect to the base cover 49 of the fixing unit 44 by intent, the end-point switch 66 is excessively operated by the end-point switch operation unit 56, and thus the end-point switch 66 may be broken. In the present embodiment, however, as illustrated in FIG. 8, the top 49a of the base cover 49 is formed with the over-speed regulation rib 52 and the over-speed regulation rib 53, and as illustrated in FIG. 9, the bottom 45a of the pan movable unit 45 is formed with the over-speed regulation rib 54 and the over-speed regulation rib 55. These are each disposed so as to prevent the end-point switch 66 from being excessively operated by the end-point switch operation unit 56 and so as not to interfere with a proper operation of the end-point switch 66 by the end-point switch operation unit 56.

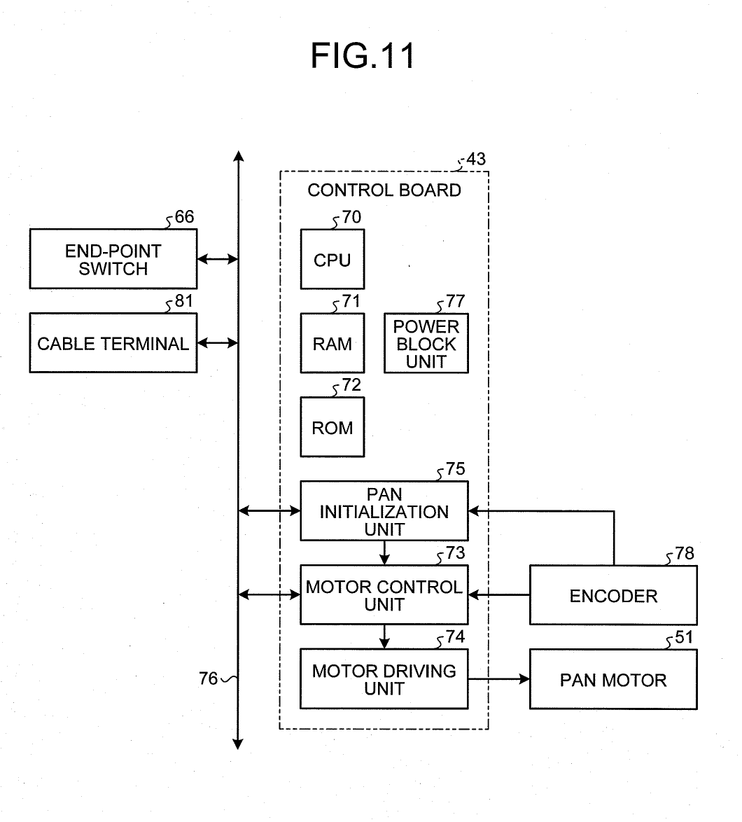

As illustrated in FIG. 11, the control board 43 includes a Central Processing Unit (CPU) 70, a Random Access Memory (RAM) 71, a Read Only Memory (ROM) 72, and a power block unit 77. A control program is stored in the ROM 72. The control program is readout on the CPU 70 and is executed on the CPU 70 to cause the hardware such as the CPU 70 to function as a motor control unit (motor control means) 73, a motor driving unit (motor driving means) 74, and a pan initialization unit (pan initialization means) 75. The power is supplied to the power block unit 77 through a battery box accommodated in the cradle body 41 or through DC jack from the exterior.

The motor driving unit 74 drives the pan motor 51. The motor control unit 73 controls the motor driving unit 74 based on the control signal input from a bus 76. In addition, the motor control unit 73 feedback-controls the motor driving unit 74 based on the detected result input from the encoder 78. Further, the motor control unit 73 outputs a signal for monitoring the status of the cradle 2, for example, rotational position notifying information (information signal) including a rotational position of the output shaft of the cradle 2 to a cable terminal 81, based on the detected result input from the encoder 78. The pan initialization unit 75 executes an initialization (end-point out) of the horizontal rotation of the pan motor 51 based on a command input from the bus 76. In addition, the pan initialization unit 75 executes the initialization (end-point out) of the horizontal rotation of the pan motor 51 at the time of a power-on. In addition, the pan initialization unit 75 outputs information signal including initialization completion notification to the cable terminal 81.

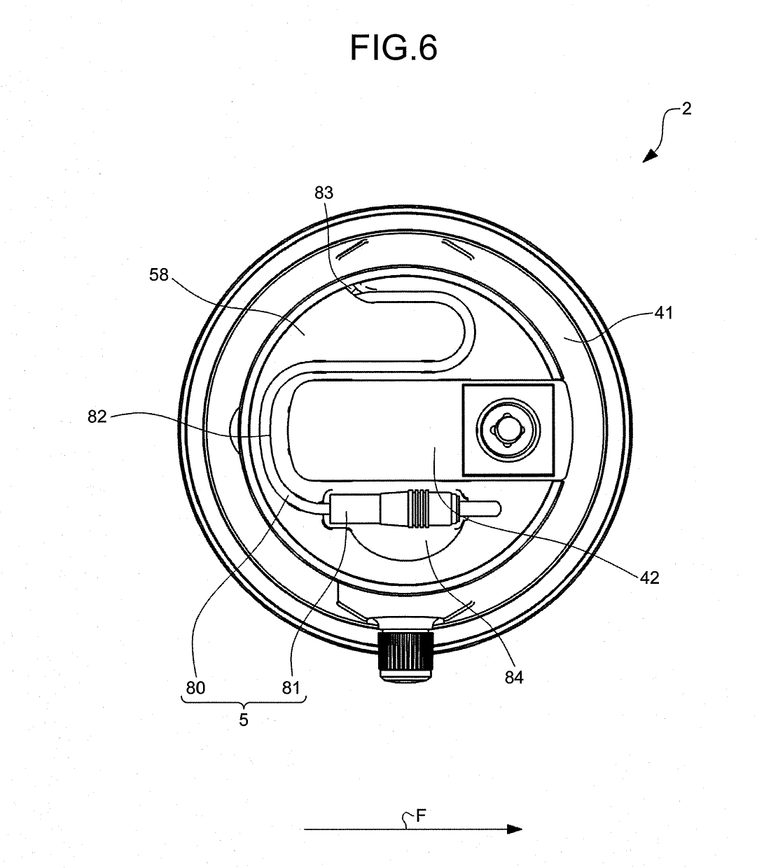

As illustrated in FIGS. 5 and 6, the connection cable 5 is a cable for connecting the control board 43 to the camcorder 3. The connection cable 5 includes a cable body 80 and the cable terminal 81. The cable terminal 81 is larger than the cable body 80 in diameter. Here, as illustrated in FIG. 6, a cable accommodating groove 82 is formed at the top plate 58 to accommodate the connection cable 5. The cable accommodating groove 82 extends in a serpentine shape. The cable accommodating groove 82 extends so as to avoid the plate 42 attached to the cradle body 41. As seen from the imaging direction F of the camcorder 3 mounted on the cradle 2, a cable entrance 83 for drawing the connection cable 5 into the cradle body 41 is disposed at a left side of the plate 42. In addition, as seen from the imaging direction F of the camcorder 3 mounted on the cradle 2, a cable terminal accommodating unit 84 for accommodating the cable terminal 81 within the cable accommodating groove 82 is disposed at a right side of the plate 42.

Smart Phone 4

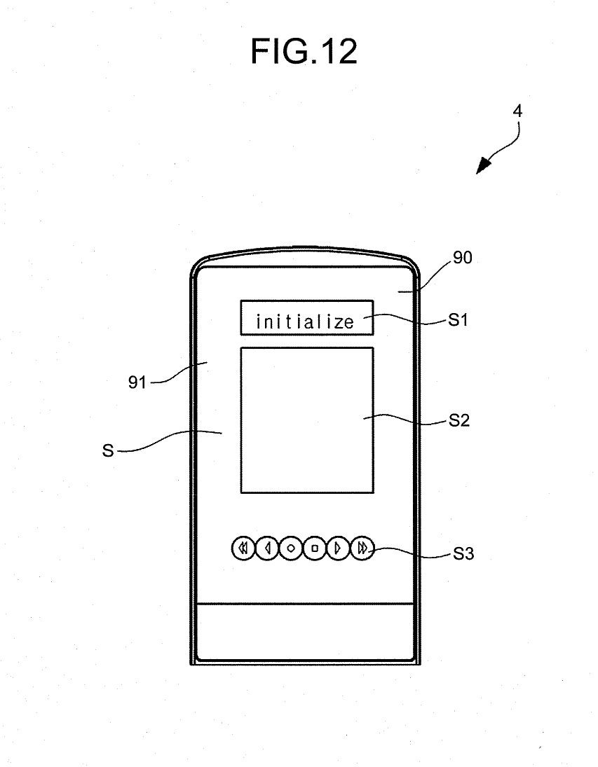

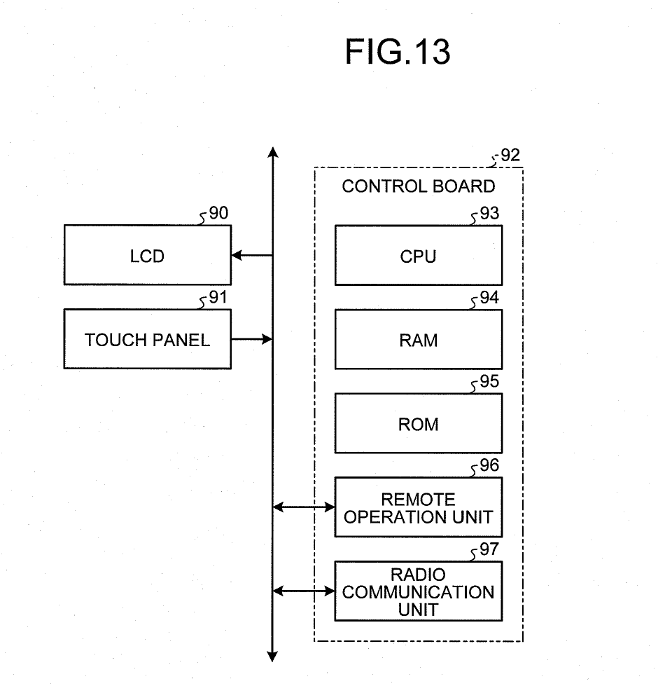

The smart phone 4 will be described below with reference to FIGS. 12 and 13. As illustrated in FIGS. 12 and 13, the smart phone 4 includes an LCD 90, a touch panel 91, and a control board 92. The control board 92 includes a Central Processing Unit (CPU) 93, a Random Access Memory (RAM) 94, and a Read Only Memory (ROM) 95. A control program is stored in the ROM 95. The control program is readout on the CPU 93 and is executed on the CPU 93 to cause the hardware such as the CPU 93 to function as a remote operation unit (remote operation means) 96 and a radio communication unit (radio communication means) 97.

As illustrated in FIG. 12, the remote operation unit 96 displays a remote operation screen S on the LCD 90. The remote operation screen S includes an initialization button S1, a through video display region S2, and a cradle remote control button group S3. The initialization button S1 is a button for initializing the control of the pan operation of the cradle 2. The through video display region S2 is a region for displaying the video imaged by the camcorder 3. The cradle remote control button group S3 is a button for remotely operating the cradle 2 and the camcorder 3. The cradle remote control button group S3 includes: a pan button for operating the cradle 2 with the pan operation at a predetermined angle step or a predetermined angular velocity in a clockwise or counter-clockwise direction; a pan speed change button for changing a speed of the pan operation; an imaging start button for starting the imaging in the camcorder 3; and an imaging stop button for stopping the imaging by the camcorder 3.

The radio communication unit 97 performs the radio communication with the camcorder 3.

Operation

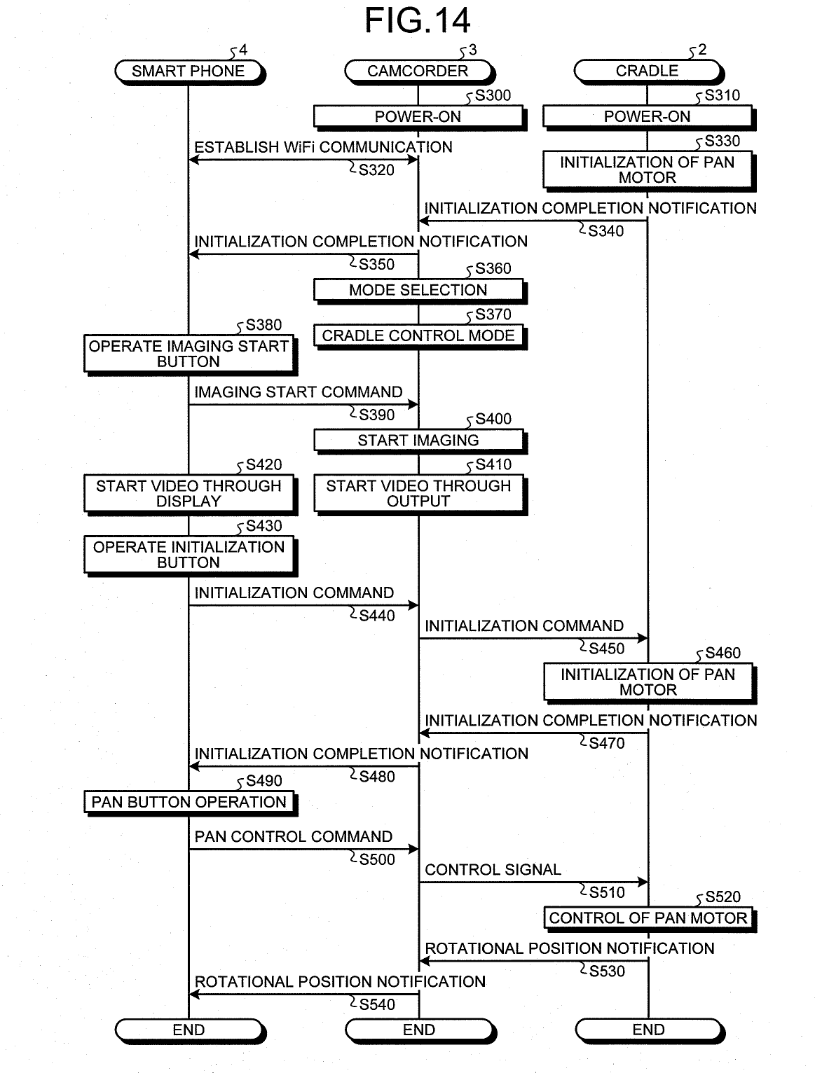

An operation of the remote cradle control system 1 will be described below with reference to FIG. 14.

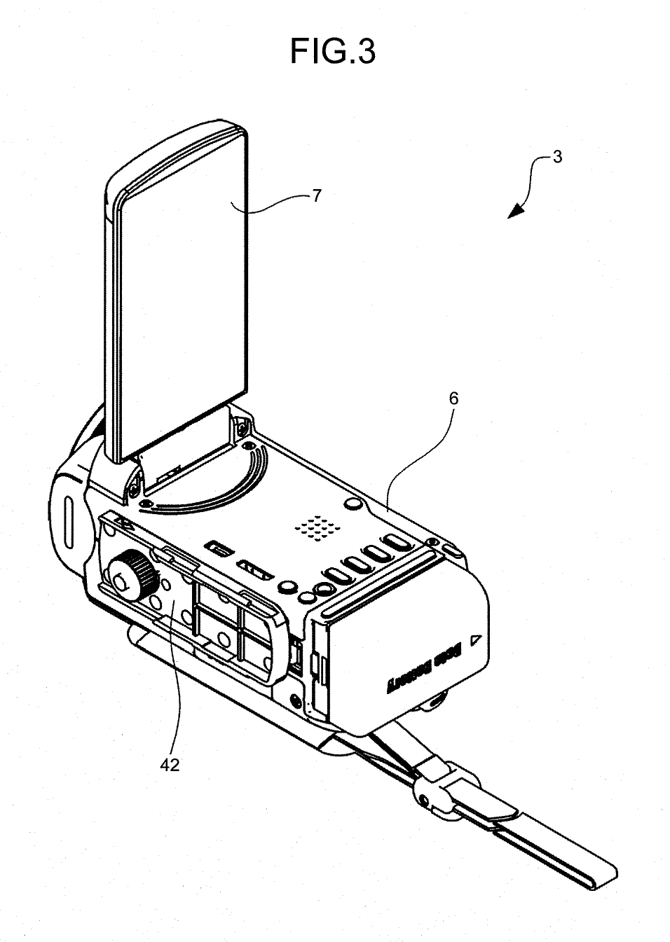

In order to attach the camcorder 3 to the cradle 2, first, as illustrated in FIG. 3, the plate 42 detached from the cradle body 41 is attached to the camcorder 3. Specifically, the thread 63a of the attachment screw 63 of the plate 42 illustrated in FIG. 10 is screwed into the tripod-attaching female screw unit 9 of the camcorder body 6 of the camcorder 3 illustrated in FIG. 2. In the present embodiment, as described above, the tripod-attaching female screw unit 9 of the camcorder body 6 of the camcorder 3 is electrically connected to the ground of the control board 8 of the camcorder 3 illustrated in FIG. 4. Accordingly, in this state, the body-side contact tip 63c of the attachment screw 63 of the plate 42 illustrated in FIG. 10 is electrically connected to the ground of the control board 8 of the camcorder 3 illustrated in FIG. 4.

Then, the connection cable 5 illustrated in FIG. 6 is detached from the cable accommodating groove 82 of the top plate 58 of the cradle body 41. Further, the plate 42 attached to the camcorder 3 is attached to the cradle body 41. At this time, the body-side contact tip 63c of the attachment screw 63 of the plate 42 illustrated in FIG. 10 enters the contact exposing window 61 of the top plate 58 illustrated in FIG. 7 and is electrically connected to the contact 60 which is in a partially exposed state within the contact exposing window 61. As a result, the ground of the control board 8 of the camcorder 3 is electrically connected to the ground of the control board 43 of the cradle 2 through the tripod-attaching female screw unit 9 illustrated in FIG. 2, the attachment screw 63 of the plate 42 illustrated in FIG. 10, and the contact 60 illustrated in FIG. 7, in turn.

Subsequently, when the plate 42 attached to the camcorder 3 is attached to the cradle body 41, for example, as illustrated in FIG. 2, the AV connection terminal 11 is exposed so that the folding LCD 7 of the camcorder 3 is in the open state. Then, the cable terminal 81 of the connection cable 5 illustrated in FIG. 6 is connected to the AV connection terminal 11.

With this state, as illustrated in FIG. 14, the power-on of the camcorder 3 is executed (S300), and the power-on of the cradle 2 is executed (S310). When the camcorder 3 is powered-on (S300), the WiFi communication between the radio communication unit 28 of the camcorder 3 illustrated in FIG. 4 and the radio communication unit 97 of the smart phone 4 illustrated in FIG. 13 is established (S320). In addition, when the cradle 2 is powered-on (S310), the pan initialization unit 75 of the cradle 2 illustrated in FIG. 11 executes the initialization of the control of the pan operation (S330). Specifically, the pan initialization unit 75 of the cradle 2 causes the pan motor 51 to rotate in clockwise direction until the end-point switch 66 is operated. Then, the pan initialization unit 75 of the cradle 2 obtains a rotational position of the output shaft of the pan motor 51 when the end-point switch 66 is operated based on the detected result input from the encoder 78 when the end-point switch 66 is operated. The pan initialization unit 75 of the cradle 2 causes the RAM 71 to store the obtained rotational position therein.

Similarly, the pan initialization unit 75 of the cradle 2 causes the pan motor 51 to rotate in counter-clockwise direction until the end-point switch 66 is operated. Then, the pan initialization unit 75 of the cradle 2 obtains a rotational position of the output shaft of the pan motor 51 when the end-point switch 66 is operated based on the detected result input from the encoder 78 when the end-point switch 66 is operated. The pan initialization unit 75 of the cradle 2 causes the RAM 71 to store the obtained rotational position therein. Then, the pan initialization unit 75 of the cradle 2 calculates a neutral position of the output shaft of the pan motor 51 based on the obtained two rotational positions and causes the RAM 71 to store the calculated result therein. When the initialization of the pan motor is completed (S330), the pan initialization unit 75 outputs an initialization completion notification to the camcorder 3 (S340). When the initialization completion notification is input from the cradle 2 (S340), the camcorder 3 transfers the initialization completion notification to the smart phone 4 (S350).

Then, a mode selection screen is displayed on the folding LCD 7 of the camcorder 3 to prompt a mode selection (S360).

In the present embodiment, the camcorder 3 includes a playback mode and a cradle control mode. The playback mode is a mode in which the signal selection unit 27 illustrated in FIG. 4 selects the audio signal and the video signal output from the audio/video signal output unit 26, as the signal output from the AV connection terminal 11. Accordingly, in the playback mode, the audio signal and the video signal output from the audio/video signal output unit 26 are output from the AV connection terminal 11. In the playback mode, further, the signal selection unit 27 also outputs the audio signal and the video signal output from the audio/video signal output unit 26 to the folding LCD 7 and the like. Thus, the folding LCD 7 becomes a state in which the video signal output from the audio/video signal output unit 26 is displayed. Meanwhile, the cradle control mode is a mode in which the signal selection unit 27 illustrated in FIG. 4 selects the control signal output from the control signal output unit 24, as a signal output from the AV connection terminal 11. Accordingly, in the cradle control mode, the control signal output from the control signal output unit 24 is output from the AV connection terminal 11. In plain words, the cradle control mode is a mode for controlling the pan operation of cradle 2 using the camcorder 3 or the smart phone 4.

Hereinafter, it is assumed that the user operates the touch panel provided in the folding LCD 7 of the camcorder 3 to select the cradle control mode (S370). Then, as illustrated in FIG. 12, a remote operation screen S is displayed on the smart phone 4.

With this state, when the user operates the imaging start button of the cradle remote start button group S3 illustrated in FIG. 12 (S380), the smart phone 4 outputs imaging start command to the camcorder 3 (S390). When the imaging start command is input from the smart phone 4, the camcorder 3 starts the imaging (S400) and concurrently causes the audio/video storage unit 25 to store the video signal and the audio signal generated by imaging therein. Then, the audio/video signal output unit 26 of the camcorder 3 starts the through output of the video signal and the audio signal stored in the audio/video storage unit 25 to the smart phone 4 via the WiFi communication (S410). The through output of the video signal and the audio signal represents a format in which the video signal and the audio signal are output in real time. In response to this, the smart phone 4 starts the through display of the video signal and the audio signal input from the camcorder 3 on the through video display region S2 (S420).

The through display represents that the input video signal and audio signal are displayed on the through video display region S2 in real time.

Here, it is assumed that the user intends to initialize the control of the pan operation of the cradle 2. In this case, the user operates the initialization button S1 illustrated in FIG. 12 (S430). Then, the remote operation unit 96 outputs the initialization command to the control signal output unit 24 of the camcorder 3 (S440). The control signal output unit 24 of the camcorder 3 outputs the input initialization command to the pan initialization unit 75 of the cradle 2 (S450). Then, the pan initialization unit 75 of the cradle 2 executes the initialization of the control of the above-described pan operation (S460). Further, when the initialization of the pan motor is completed (S460), the pan initialization unit 75 outputs the initialization completion notification to the camcorder 3 (S470). When the initialization completion notification is input from the cradle 2 (S470), the camcorder 3 transfers the initialization completion notification to the smart phone 4 (S480).

In addition, if the user wants to initialize the pan operation of the cradle 2, it may be achieved by pressing the initialization button 10 illustrated in FIG. 2, instead of operating the initialization button S1 illustrated in FIG. 12 (S430). In this case, the control signal output unit 24 of the camcorder 3 outputs the initialization command to the pan initialization unit 75 of the cradle 2 (S450), and the pan initialization unit 75 of the cradle 2 executes the initialization of the control of the above-described pan operation (S460). Further, when the initialization of the pan motor is completed (S460), the pan initialization unit 75 outputs the initialization completion notification to the camcorder 3 (S470).

Here, it is assumed that the user wants to adjust the imaging direction F of the camcorder 3. In this case, the user operates the pan button of the cradle remote control button group S3 of the smart phone 4 illustrated in FIG. 12 (S490). Then, the remote operation unit 96 of the smart phone 4 outputs the pan control command to the control signal output unit 24 of the camcorder 3 (S500). The control signal output unit 24 of the camcorder 3 outputs the control signal stored in the control signal storage unit 23 to the motor control unit 73 of the cradle 2 based on the pan control command input from the smart phone 4 (S510). Further, the motor control unit 73 of the cradle 2 controls the driving of the pan motor 51 based on the input control signal (S520). When the control of the driving of the pan motor 51 is completed (S520), the motor control unit 73 of the cradle 2 outputs the rotational position notification information including the present rotational position of the output shaft of the cradle 2 to the signal selection unit 27 of the camcorder 3 (S530). The signal selection unit 27 of the camcorder 3 transfers the input rotational position notification information to the remote operation unit 96 of the smart phone 4 (S540).

The remote operation unit 96 of the smart phone 4 displays the present rotational position of the output shaft of the cradle 2 on the remote operation screen S based on the input rotational position notification information.

Above, the operation of the remote cradle control system 1 has been described. The operation of the remote cradle control system 1 may be changed as follows, for example.

The user displays the mode selection screen for prompting the mode selection on the LCD 90 of the smart phone 4, instead of selecting the cradle control mode by operating the touch panel provided in the folding LCD 7 of the camcorder 3 (S370), and the user may operate the touch panel 91 so that the cradle control mode is selected.

In addition, in the above-described embodiment it is assumed that the camcorder 3 takes the moving image, but the camcorder 3 may take a still image instead of the moving image. Even when the camcorder 3 takes the still image instead of the moving image, the configuration for controlling the pan operation of the cradle 2 using the camcorder 3 or the smart phone 4 significantly functions.

Above, the embodiment of the invention is described, but the above-described embodiment has following features.

(1-1) The camcorder (imaging device) 3 is mounted on the cradle 2 capable of controlling the pan operation. The camcorder 3 is provided with the control signal output unit (control signal output means) 24 for outputting the control signal, which causes the cradle 2 to execute the desired pan operation, to the cradle 2. According to the above configuration, the pan operation of the cradle 2 may be controlled from the camcorder 3 side.

(1-2) The camcorder 3 is further provided with: the audio/video storage unit (audio/video storage means) 25 for storing the audio signal and the video signal; the audio/video signal output unit (audio/video signal output means) 26 for outputting the audio signal and the video signal stored in the audio/video storage unit 25; and the AV connection terminal (connection terminal) 11 through which the audio/video control signal output unit 24 outputs the audio signal and the video signal to the exterior.

(1-3) The control signal output unit 24 outputs the control signal to the cradle 2 through the AV connection terminal 11. According to the above configuration, it is possible to omit a dedicated terminal through which the control signal output unit 24 outputs the control signal to the cradle 2.

(1-4) The camcorder 3 further includes the signal selection unit (signal selection means) 27 for selecting either one of the audio signal and the video signal output from the audio/video signal output unit 26 and the control signal output from the control signal output unit 24, as the signal output from the AV connection terminal 11.

(1-5) The cradle 2 is capable of mounting the camcorder 3 and capable of controlling the pan operation. The cradle 2 includes: the pan motor 51 used for the pan operation; the motor driving unit (motor driving means) 74 for driving the pan motor 51; and the motor control unit (motor control means) 73 for controlling the motor driving unit 74 based on the control signal input from the camcorder 3.

(1-6) The cradle 2 further includes the connection cable 5 connected to the AV connection terminal 11 from which the audio signal or the video signal of the camcorder 3 is output. The control signal is input from the camcorder 3 through the connection cable 5.

(2-1) From the other viewpoint, further, the cradle 2 mounted with the camcorder 3 is capable of controlling the pan operation. The cradle 2 is provided with the control board 43 for controlling the pan operation and the attachment screw 63 which is screwed into the tripod-attaching female screw unit 9 of the camcorder 3. The ground of the control board 43 and the attachment screw 63 are electrically connected to each other. That is, when the tripod-attaching female screw unit 9 of the camcorder 3 is electrically connected to the ground of the control board 8 of the camcorder 3, according to the above configuration, it is possible to connect the ground of the control board 43 of the cradle 2 and the ground of the control board 8 of the camcorder 3 to each other with the simple configuration.

(2-2) The cradle 2 mounted with the camcorder 3 is capable of controlling the pan operation. The cradle 2 includes: the control board 43 for controlling the pan operation; the cradle body 41 for accommodating the control board 43; and the plate (fixture) 42 which is attachable to and detachable from the cradle body 41 and the camcorder 3. The plate 42 includes the plate body (fixture body) 62 and the attachment screw 63 which is screwed into the tripod-attaching female screw unit 9 of the camcorder 3, while being rotatably supported by the plate body 62. The cradle body 41 includes: an attaching/holding unit (corresponding to the base 57 and the top plate 58); and the contact 60 with which the attachment screw 63 of the plate 42 comes in contact when the plate 42 is held to the attaching/holding unit, while being supported by the attaching/holding unit. The ground of the control board 43 and the contact 60 are electrically connected to each other. That is, when the tripod-attaching female screw unit 9 of the camcorder 3 is electrically connected to the ground of the control board 8 of the camcorder 3, according to the above configuration, it is possible to connect the ground of the control board 43 of the cradle 2 and the ground of the control board 8 of the camcorder 3 to each other with the simple configuration.

(2-3) The contact 60 is the elastic metal piece.

(3-1) From another viewpoint, further, the cradle 2 mounted with the camcorder 3 is capable of controlling the pan operation. The cradle 2 is provided with the control board 43 for controlling the pan operation, the cradle body 41 for accommodating the control board 43, and the connection cable 5 for connecting the control board 43 to the camcorder 3. The cable accommodating groove 82 is formed in the cradle body 41 to accommodate the connection cable 5. According to the above configuration, when not using the connection cable 5, it is possible to accommodate the connection cable 5.

(3-2) The cable accommodating groove 82 extends in the serpentine shape. According to the above configuration, it is possible to ensure longwise the cable accommodating groove 82 with a small area.

(3-3) The cradle 2 further includes the plate 42 which is attachable to and detachable from the cradle body 41 and the camcorder 3. The cable accommodating groove 82 extends so as to avoid the plate 42 attached to the cradle body 41. According to the above configuration, it is possible to ensure longwise the cable accommodating groove 82 while avoiding the plate 42.

(3-4) As seen from the imaging direction F of the camcorder 3 mounted on the cradle 2, the cable entrance 83 for drawing the connection cable 5 into the cradle body 41 is disposed at the left side of the plate 42. Since the AV connection terminal 11 is disposed at the left side 6b of the camcorder body 6, the above configuration is reasonable.

(3-5) The connection cable 5 includes the cable terminal 81 which is connected to the camcorder 3. As seen from the imaging direction F of the camcorder 3 mounted on the cradle 2, the cable terminal accommodating unit 84 for accommodating the cable terminal 81 of the cable accommodating groove 82 is disposed at the right side of the plate 42. According to the above configuration, when the folding LCD (folding monitor) 7 of the camcorder 3 is located at the left side as seen from the imaging direction F of the camcorder 3, the cable terminal 81 under the state of being accommodated in the cable terminal accommodating unit 84 has no influence on the opening and closing of the folding LCD 7.

Note 1

The remote cradle control system 1 includes the cradle 2 and the camcorder 3. The camcorder 3 has the AV connection terminal 11. The cradle 2 and the camcorder 3 perform two-way communication through the AV connection terminal 11. The two-way communication includes: the communication in which the control signal is output to the cradle 2 from the camcorder 3 so that the camcorder 3 controls the pan operation of the cradle 2; and the communication in which the signal is output to the camcorder 3 from the cradle 2 so that the camcorder 3 monitors the operation of the cradle 2.

Note 2

The remote cradle control system 1 includes the cradle 2, the camcorder 3, and the smart phone 4. The camcorder 3 includes the AV connection terminal 11. The cradle 2 and the camcorder 3 perform two-way communication through the AV connection terminal 11. The camcorder 3 and the smart phone 4 perform two-way communication through the WiFi communication (radio communication). The smart phone 4 controls the pan operation of the cradle 2 by way of the camcorder 3. The smart phone 4 monitors the present status of the cradle 2 by way of the camcorder 3. Accordingly, the smart phone 4 can feedback-control the pan operation of the cradle 2.

Above, an exemplary embodiment of the invention has been described, but the embodiment described above can be modified as follows.

The pan operation of the cradle 2 is performed by the electric power and the tilt operation of the cradle 2 is manually performed, but the tilt operation may be performed by the electric power, similar to the pan operation.

In addition, a tablet-type personal computer may be used instead of the smart phone 4.

According to the present invention, it is possible to control a pan operation or a tilt operation of a cradle from an imaging device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An imaging device mounted on a cradle configured to control any one of a pan operation and a tilt operation, the imaging device comprising:
a control signal output unit configured to output a control signal that executes any one of a desired pan operation and tilt operation to the cradle.

2. The imaging device according to claim 1, further comprising:
an audio/video storage unit that stores any one of an audio signal and a video signal;
an audio/video signal output unit that outputs any one of the audio signal and the video signal stored in the audio/video storage unit; and
a connection terminal that is configured so that the audio/video signal output unit outputs any one of the audio signal and the video signal to an exterior.

3. The imaging device according to claim 2, wherein the control signal output unit outputs the control signal to the cradle through the connection terminal.

4. The imaging device according to claim 3, further comprising:
a signal selection unit that selects any one of the audio signal and the video signal output from the audio/video signal output unit and the control signal output from the control signal output unit, as a signal output from the connection terminal.

5. A cradle that mounts an imaging device and configured to control any one of a pan operation and a tilt operation, the cradle comprising:
a pan motor used for any one of a pan operation and a tilt motor used for a tilt operation;
a motor driving unit that drives any one of the pan motor and the tilt motor; and
a motor control unit that controls the motor driving unit based on a control signal input from the imaging device.

6. The cradle according to claim 5, further comprising:
a connection cable that is connected to a connection terminal to which any one of an audio signal and a video signal of the imaging device is output,
wherein the control signal is input from the imaging device through the connection cable.

7. A cradle which is mounted with an imaging device and configured to control any one of a pan operation and a tilt operation, the cradle comprising:
a control board that is configured to control any one of the pan operation and the tilt operation; and
an attachment screw that is screwed into a tripod-attaching female screw unit of the imaging device,
wherein a ground of the control board and the attachment screw are electrically connected to each other.

8. A cradle which is mounted with an imaging device and configured to control any one of a pan operation and a tilt operation, the cradle comprising:
a control board that is configured to control any one of the pan operation and the tilt operation;
a cradle body that accommodates the control board; and
a fixture that is detachable to the cradle body and the imaging device,
wherein the fixture includes a fixture body, an attachment screw that is screwed into a tripod-attaching female screw unit of the imaging device while being rotatably supported by the fixture body,
the cradle body includes an attaching/holding unit configured to hold the fixture and a contact with which the attachment screw of the fixture comes in contact when the attachment screw is held to the attaching/holding unit, while being supported by the attaching/holding unit, and
a ground of the control board and the contact are electrically connected to each other.

9. The cradle according to claim 8, wherein the contact is an elastic metal piece.

10. A cradle which is mounted with an imaging device and configured to control any one of a pan operation and a tilt operation, the cradle comprising:
a control board that is configured to control any one of the pan operation and the tilt operation;
a cradle body that accommodates the control board; and
a connection cable that is configured to connect the control board to the imaging device,
wherein a cable accommodating groove is formed in the cradle body to accommodate the connection cable.

11. The cradle according to claim 10, wherein the cable accommodating groove extends in a serpentine shape.

12. The cradle according to claim 11, further comprising:
a fixture that is detachable to the cradle body and the imaging device,
wherein the cable accommodating groove extends so as to avoid the fixture which is attached to the cradle body.

13. The cradle according to claim 12, wherein a cable entrance for drawing the connection cable into the cradle body is disposed at a left side of the fixture as seen from an imaging direction of the imaging device mounted on the cradle.

14. The cradle according to claim 12, wherein the connection cable includes a cable terminal that is connected to the imaging device, and a cable terminal accommodating unit that accommodates the cable terminal of the cable accommodating groove is disposed at a right side of the fixture as seen from the imaging direction of the imaging device mounted on the cradle.
